(19) United States
(12) Patent Application Publication
(10) Pub. No.: US 2010/0239126 A1
(43) Pub. Date: Sep. 23, 2010

(54) APPARATUS AND METHOD FOR MEASURING A DISTANCE TO AN EARDRUM

(75) Inventors: Alexander Grafenberg, Effeltrich (DE); Martin Kunz, Munchen (DE); Uwe Rass, Nurnberg (DE); Frank Wagner, Quinterra (SG)

Correspondence Address: LERNER GREENBERG STEMER LLP, P O BOX 2480, HOLLYWOOD, FL, 33022-2480, US

(73) Assignee: SIEMENS MEDICAL INSTRUMENTS PTE. LTD., Signapore (SG)

(21) Appl. No.: 12/729,386

(22) Filed: Mar. 23, 2010

(30) Foreign Application Priority Data
Mar. 23, 2009 (DE) 10 2009 014 463.3

(51) Int. Cl. G06K 9/00; H04N 7/18

(52) U.S. Cl. 382/106; 348/65; 348/E07.085

(57) ABSTRACT

An apparatus for measuring a distance to an eardrum has an optical sensor and a signal-processing device. The optical sensor acquires an image of the eardrum and the signal-processing device determines an area or separation extending perpendicular to the spacing distance to be measured in the image and determines the spacing distance to the eardrum as a function of the determined area or separation. A corresponding method includes the steps of acquiring an image of the eardrum, determining an area or separation extending perpendicular to the distance to be measured in the image, and determining the distance as a function of the determined area or separation. A projection image may be projected onto or into a vicinity of the eardrum and then the distance can be determined from the separation between the projection image and the eardrum or the image center of the image.

### CROSS-REFERENCE TO RELATED APPLICATION

This application claims the priority, under 35 U.S.C. §119, of German patent application DE 10 2009 014 463, filed Mar. 23, 2009; the prior application is herewith incorporated by reference in its entirety.

### BACKGROUND OF THE INVENTION

### Field of the Invention

The invention relates to an apparatus and a method for measuring the distance of an instrument, inserted into an auditory canal, from the eardrum in the auditory canal. Instruments are inserted into the auditory canal for examination and treatment for a wide variety of reasons, often for examining the hearing organ or for treating hearing damage.

By way of example, the outer auditory canal and the eardrum are examined with the aid of an otoscope within the scope of otoscopy. An otoscope has an elongate tube to be inserted into the outer auditory canal, which tube can be used to obtain images from the interior of the auditory canal, either directly or by video transmission. In particular, inserting the otoscope into the auditory canal is necessary because the auditory canal is often angular or convoluted and so a direct and straight-lined observation from the outside is impossible.

Within the scope of hearing aid therapy, different hearing aid designs are used, the different apparatus components of which are inserted into the auditory canal to different depths. In particular, so-called BTE (behind-the-ear) devices have a tube reaching far into the auditory canal. The tube is used either to guide acoustic signals from the hearing-aid housing arranged behind the ear of the hearing-aid wearer into the auditory canal or instead to lead electrical signals to a receiver that is arranged on the tube in the auditory canal. The tube of a BTE device can be placed into the auditory canal at different depths, wherein an individual placement for the patient can be determined by trials.

Within the scope of an otoscopy examination, the placement of a BTE hearing aid tube or other manipulations in the auditory canal, it is important not to touch the eardrum of the patient or the affected person. Contact with the eardrum is perceived to be unpleasant or painful. For this purpose, it is necessary to monitor the separation between the instrument inserted into the auditory canal and the eardrum.

The simplest and conventional method for monitoring the separation distance is optical monitoring by the operator or user of the instrument. For example, during an otoscopy examination, the eardrum can always be observed in the images obtained by the otoscope. When placing hearing aid components, e.g. receivers, or measurement probes, the audiologist or operator can likewise optically monitor the situation. However, optical monitoring is prone to errors to the extent that, on the one hand, monitoring the separation requires particular attentiveness of the operator and said operator can be distracted. On the other hand, it is often difficult to assess the separation between the instrument and the eardrum by optical means due to the distorted optical display conditions in respect of the illumination, the perspective and the aperture, and so in particular small separations can in general only be ascertained with great experience and attentiveness.

In order to address the problems of optical separation monitoring by the operator, international patent application publication WO 02/16867 A1 described an instrument that has a collision detector. The instrument is used for optical 3D acquisition of the auditory canal and can be inserted into the auditory canal for this purpose. The collision detector is arranged at the distal end of the instrument, which can additionally be designed using a soft plastics material, e.g. silicone. The functionality of the collision detector is not described in detail.

Commonly assigned German published patent application DE 10 2006 057 099 A1 discloses a holography unit for examining the auditory canal. The holography unit records optical images of the interior of the auditory canal and a 3D image of the auditory canal can be obtained therefrom. As soon as the 3D image is available, the position of the holography unit and, thus, the separation thereof from the eardrum are also known. However, there is no automatic separation monitoring, so the latter is subject to the attentiveness of the operator.

U.S. Pat. No. 5,044,373 describes an instrument for acoustic measurements in the auditory canal. The instrument is used within the scope of adapting a hearing aid to the individual circumstances of the respective hearing-aid wearer. It comprises a measurement probe that can be inserted into the auditory canal. The measurement probe has a sensor for measuring the distance between the measurement probe and the eardrum. The sensor can operate using sound waves, electromagnetic waves or light. If light is used, either a run-time measurement using the reflected light or a measurement of the signal strength of the reflected light is undertaken. A run-time measurement can ensure great measurement accuracy; however, it is relatively complex in its implementation. The measurement of the signal strength can be implemented with relatively low implementation complexity; however, the measurement accuracy thereof is relatively low and the measurement method is susceptible to the sensor dirtying.

### SUMMARY OF THE INVENTION

It is accordingly an object of the invention to provide a method and a device which overcome the above-mentioned disadvantages of the heretofore-known devices and methods of this general type and which permit a measurement of a separation between an instrument inserted into an auditory canal and the eardrum of the auditory canal, which measurement is conducted automatically and the measurement accuracy of which is ensured to be sufficient to be able reliably to warn about contact with the eardrum. Moreover, the method should be implementable with little complexity and, in light of the little space available in the ear, in a space-saving fashion.

With the foregoing and other objects in view there is provided, in accordance with the invention, an apparatus for measuring a distance between a distal end of an instrument inserted into a canal and a terminal boundary of the canal, comprising:

an optical sensor disposed at the distal end of the instrument and configured to acquire an image of the terminal boundary of the canal;

a signal-processing device connected to said optical sensor, said signal-processing device determining an area or separation extending perpendicularly to the distance to be measured in the image, and determining the distance between the distal end of the instrument and the terminal boundary of the canal in dependence on the area or separation.

In particular, the instrument is configured for insertion into an auditory canal and the terminal boundary of the canal is formed by an eardrum.

In other words, a basic concept of the invention is to provide an apparatus for measuring a distance between the distal end of an instrument, designed to be inserted into an auditory canal, and a boundary at the end, in particular the eardrum, of the auditory canal, into which the instrument has been inserted. The apparatus comprises an optical sensor and a signal-processing device. According to the basic concept of the invention, the optical sensor acquires an image of the boundary at the end. The signal-processing device determines an area or separation extending perpendicular to the distance to be measured in the image and determines the distance as a function of the determined area or separation. Here, perpendicular expresses that the optical sensor is basically oriented in the direction of the distance to be measured and therefore the image plane of the image is not parallel to the distance to be measured.

A primarily important feature of the basic concept is that an optical sensor available in any case can be used because the sensor image data are analyzed in respect of conventional geometric image features, namely area or separation. Thus, use can be made of images in the visible wavelength band and a sensor operating in this band, which sensor, for example, can be available in any case for other purposes on an otoscope or another instrument. Optical sensors, e.g. miniature image sensors or sensor attachments using fiber-optic cables, which are small enough for use in the auditory canal, are commonly available.

Additionally, only a separation-determining algorithm is required in the signal-processing device and further adaptations are unnecessary. Suitable image-processing algorithms are commonly available. The low error-susceptibility in the determination and analysis of geometric image data is particularly advantageous because said determination and analysis are only subject to few disturbances. Particularly the use of an optical sensor provided in any case for other purposes additionally increases the safety of use because massive image disturbances, which could negatively affect the image-processing algorithm, would also be perceived by the operator, who is thus continuously informed about possible problems due to image disturbances during the image processing.

Not least, the proposed analysis of the separation information also can be implemented in a simple fashion from the image data because no additional apparatus components have to be provided, and because separations and areas can be determined solely by the image-data processing unit by means of a suitable image-data processing algorithm. It is also expedient that the images to be analyzed are mainly based on known basic structures and colors, which are similar for all patients, and the low variability thereof substantially simplifies the image data analysis.

According to an advantageous development of the basic idea, the optical aperture of the sensor is constant. The significance of the aperture of the optical sensor consists of the fact that every change in the aperture also causes a change in the image scale. In order to be able to make the assumption of unchanging conditions in the image data analysis for determining the distance from the eardrum, a constant aperture therefore is advantageous because it simplifies the processing in the image-data processing algorithm.

According to a further advantageous development, the signal-processing device determines the distance additionally as a function of the optical aperture of the sensor. Should use be made of image data from an optical sensor, which data were recorded with varying apertures, for example because the operator sets changes in the aperture for the respective examination purpose, it is understood that the separations and areas in the obtained image data also change with the image scale, to be precise depending on changes in the aperture. Such changes advantageously can be taken into account by the signal-processing device and so a reliable distance analysis is possible despite changes in the aperture.

According to a further advantageous development, the signal-processing device determines an area of the boundary at the end in the image and determines the distance as a function of this area. The evaluation of areas in the optical image data lends itself to the extent that the eardrum is easily visible as a relatively uniformly colored and structured area, which can usually also be easily distinguished from the surrounding auditory canal. Using this, an image data analysis can ensure that the eardrum is reliably recognized and that the latter is distinguished from the surrounding auditory canal. It is known from the geometry of optical projections that—in the case of an unchanging aperture or image scale—they appear larger from a smaller separation. If an unchanging overall image size is assumed, an ever-increasing proportion of the area of the image thus is taken up by the eardrum, which appears to be larger as the distance decreases. Thus, the area of the image data taken up by the eardrum conversely is a measure of the distance of the optical sensor from the eardrum.

According to again a further development, the signal-processing device determines an area not containing the boundary at the end in the image and determines the distance as a function of this area.

According to another development, the apparatus comprises an optical projector designed to project a predetermined projection image and which is arranged such that it projects the projection image in the direction of the boundary at the end of the auditory canal and the signal-processing device determines a separation in the image between the projection image and the boundary at the end and determines the distance to the boundary or the eardrum as a function of this separation.

The use of a predetermined and unchanging projection image advantageously makes it possible to obtain an absolute measure of the distance of the sensor from the eardrum or the projection area. This is because even if a relative measure of the distance is given in the image when using the area of the eardrum, the absolute distance can only be determined with knowledge of the actual area of the eardrum and the aperture. In the case of a suitable choice of the projection angles, there is an additional item of information available, e.g. the known shape and size of the projection image and the known projection angle, with the aid of which the absolute distance can be determined. Possibly, after a preceding calibration, it is possible to assign a distance to a certain typical measure of the projection image, for example a diameter or a separation measure. In the case of projection geometries that are unsuitable for determining an absolute measure of the distance, the use of the projection image contributes to increasing the accuracy of the distance determination.

If the projection image is not projected in the direction of the optical axis of the sensor, but in a predetermined and known angle thereto (parallax), the displacement or the separation of the projection image to the center of the image forms a measure of the absolute distance.

According to a further advantageous development, the predetermined projection image is contoured to match the expected contour of the boundary at the end. This matching of the contour of the projection image allows a better alignment thereof in respect of the contour of the eardrum, and this helps avoid errors due to misalignments. Additionally, similar contours ease the recognition and analysis of typical separation measures between the projection image and the boundary.

According to a further advantageous development, the signal-processing device determines a separation between a contour of the projection image and a contour of the boundary at the end in the image and determines the distance as a function of this separation.

With the above and other objects in view there is also provided, in accordance with the invention, a method for measuring a distance between the distal end of an instrument, designed to be inserted into an auditory canal, and a boundary at the end, in particular the eardrum, of an auditory canal, into which the instrument has been inserted. The method comprises the steps of
(S1) acquiring an image of the boundary at the end,
(S2) determining an area or separation extending perpendicular to the distance to be measured in the image,
(S3) determining the distance as a function of the determined area or separation.

According to an advantageous development, a dependence on the optical aperture of the optical sensor used to acquire the image is additionally taken into account when determining the distance.

According to a further advantageous development, the method comprises the steps of
(S4) determining an area of the boundary at the end in the image,
(S5) determining the distance as a function of this area.

According to yet a further advantageous development, the method comprises the steps of
(S6) determining an area not containing the boundary at the end in the image,
(S7) determining the distance as a function of this area.

In accordance with yet another feature of the invention, the method comprises the steps of
(S8) projecting a predetermined projection image in the direction of the boundary at the end,
(S9) determining a separation between the projection image and the boundary at the end in the image,
(S10) determining the distance as a function of this separation.

In accordance with again another feature of the invention, the predetermined projection image is contoured to match the expected contour of the boundary at the end.

In accordance with a concomitant feature of the invention, the method comprises the steps of
(S11) determining a separation between a contour of the projection image and a contour of the boundary at the end in the image,
(S12) determining the distance as a function of this separation.

Advantageously, use may be made of an optical sensor that is otherwise available for other purposes. Also, image-processing algorithms are available for analyzing image data in respect of conventional geometric imaging features, namely area or separation, and do not require any particular implementation by the apparatus. Additionally, such image-processing algorithms function largely independently of interferences in the image quality.

Other features which are considered as characteristic for the invention are set forth in the appended claims.

Although the invention is illustrated and described herein as embodied in an apparatus and method for measuring a spacing distance to an eardrum, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a schematic illustration of an ear with an instrument according to the invention being inserted into the external auditory canal;

FIG. 2 is a schematic view of an instrument with an image projection;

FIG. 3 is a diagram showing a perception angle with decreasing distance;

FIG. 4 is a perspective view of a projection image and an eardrum; and

FIG. 5 is a view showing a ratio of areas at the eardrum.

### DETAILED DESCRIPTION OF THE INVENTION

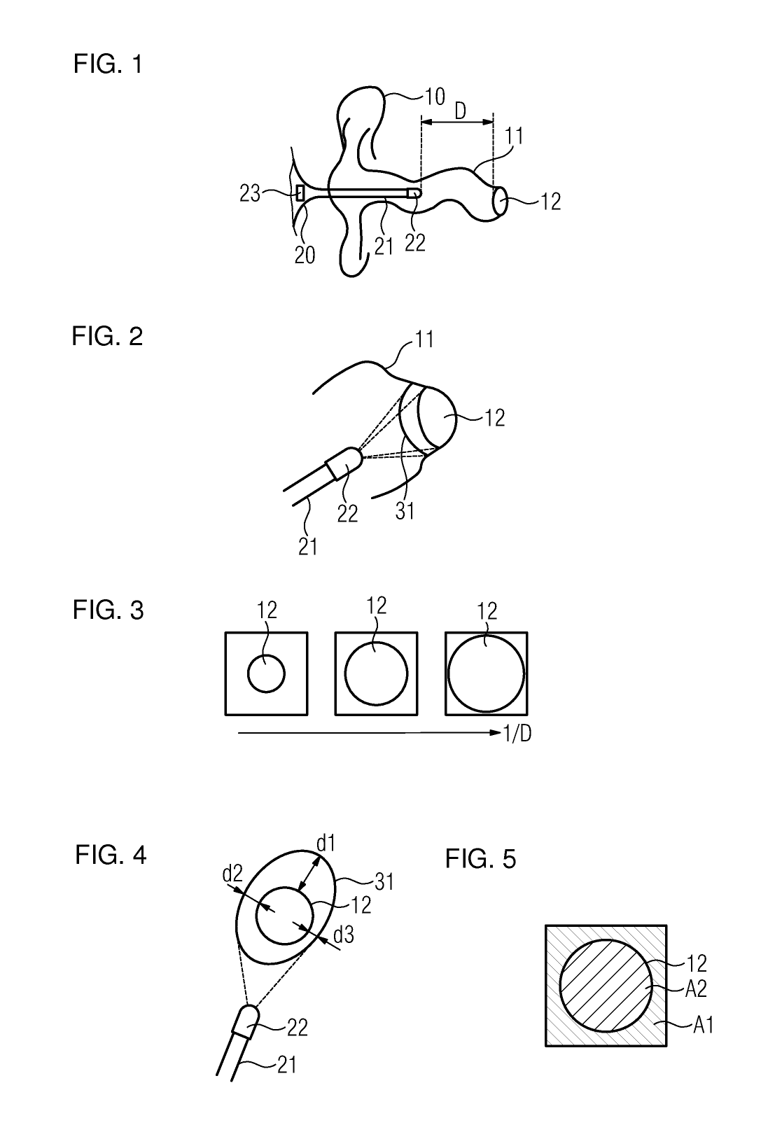

Referring now to the figures of the drawing in detail and first, particularly, to FIG. 1 thereof, there is shown an instrument 20, which is partly inserted into an external auditory canal 11. The instrument 20 may be an otoscope, an acoustic measurement probe or any other examination and treatment instrument. The instrument 20 has an elongate tube 21, which, as the case may be, can have a fixed or flexible design. An optical sensor 22 is arranged on the distal end of the instrument 20, i.e. the end facing away from the operator or user. In particular, in the case of an otoscope with electronic image data collection and transmission, this can be the image sensor of the otoscope. However, it can also be a sensor provided specifically for this. A signal-processing device 23 is connected to the optical sensor.

The auditory canal 11 is angular or convoluted and comprises the eardrum 12, also referred to as the tympanic membrane, forming the terminal boundary at the end of the auditory canal 11. The eardrum 12 separates the external auditory canal 11, and hence the outer ear, from the middle ear and inner ear (neither of the latter two are illustrated). Contact with the eardrum 12, for example by the distal end of the instrument 20, would be perceived as unpleasant or even as painful by the patient. Additionally, there is the risk of damaging the eardrum 12.

In order to avoid impairments or damage, a sufficient distance between the distal end of the instrument 20 and the eardrum 12 must be maintained at all times. The optical sensor 22 is therefore included in a system for automatic determination of the distance. The image, generated by the sensor 22, of the eardrum 12 at the end of the auditory canal is analyzed by the signal-processing device 23. In the process, separations or areas within the image are determined in terms of the explanations that follow below.

FIG. 2 illustrates the tube 21 of the instrument with the optical sensor 22. The optical sensor, or the end of the instrument, furthermore comprises an optical projector, which can be designed, for example, as a laser projection instrument in order to project a projection image 31. If, as illustrated, the instrument is oriented in the direction of the eardrum 12 arranged at the end of the auditory canal 11, the projection image 31 is also projected into the region of the eardrum. The projection image can comprise, for example, an area or a plurality of lines. In the illustrated exemplary embodiment, a line, whose contour is equal to the contour of the eardrum 12, is projected. The eardrum 12 usually appears almost circular or oval and so it is also a circular or oval projection image 31 that is projected. The projection of the projection image 31 is indicated by dashed lines. The perspective of the eardrum 12, viewed from the optical sensor 22, is likewise indicated by lines.

It is known from the optical geometry of images that the perspective subtended by the eardrum 12 increases as the spacing distance D between the sensor 22 and the eardrum 12 decreases. On the other hand, it can be seen that the projection angle of the projection image is reduced as the distance decreases due to the shape of the auditory canal 11. In the selected image geometry illustrated in an exemplary fashion, the projection image thus initially appears to be larger than the image of the eardrum 12, but the two sizes equalize as the distance decreases.

Additionally, the optical sensor 22 and the projector are not arranged on a common optical axis and so the projection angle is not parallel with the alignment of the optical sensor 22 (parallax). A measure of the absolute distance from the eardrum 12 can be determined on the basis of the known subtended angle and the separation of the projection image 31 from the center of an image recorded by the optical sensor 22.

FIG. 3 shows for illustrative purposes how the apparent size of the eardrum 12 in the image changes with decreasing distance. Depending on the properties of the imaging optical system, the size in the image changes linearly with distance.

FIG. 4 shows a constellation that can be compared to that described above with reference to FIG. 2. The tube 21 of the instrument is oriented toward the eardrum 12 such that the optical sensor is opposite the latter. Therefore, an apparatus for optical projections projects a projection image 31 in the direction of the eardrum 12. The contour of the projection image 31 is similar to the contour of the eardrum 12 to the extent that it is substantially round or oval. As explained above, the sizes of the eardrum 12 and the projection image 31 change differently in the image when the distance between the end of the tube 21 and the eardrum 12 is changed. The differences in the respective contour can be acquired by the separations d1, d2, d3 indicated in an exemplary fashion. These separations, a selected one of these separations, an average value thereof or the like therefore can be used to determine a measure of the distance between the optical sensor 22 and the eardrum 12.

FIG. 5 schematically illustrates an image of the eardrum 12 obtained by the optical sensor 22. In the image, the eardrum 12 takes up a certain area A2, which depends on the distance of the optical sensor 22 from the eardrum 12. As explained above, this area increases as the distance decreases. The remaining area A1, which does not contain the eardrum 12 correspondingly decreases as the distance decreases. Therefore, a measure of the distance can be determined from the ratio of A1 to A2, to be precise the ratio of A1 to A2 decreases as the distance decreases.

As explained above, the use of a projection image in particular, e.g. by laser projection, makes it possible to determine a very precise, possibly even absolute, measure of the distance between the sensor and the eardrum in the image by the optical sensor from the image data of the projection image and the eardrum 12. Preconditions for this are suitable optical geometric conditions, in which the projection image is projected at a predetermined angle to the central axis of the instrument, e.g. an otoscope. The use of such an optical projection thus serves, on the one hand, for a measurement of the distance that is as precise as possible; on the other hand, it can be implemented without additional complexity, particularly in instruments that scan the auditory canal on the basis of corresponding projection data.

By way of example, such methods are conventional for acquiring 3D images of the auditory canal, on the basis of which images ITE hearing aids or ear molds are produced, which are intended to be matched as precisely as possible to the individual shape of the auditory canal. Hence, the same optical components used for optimizing the housing shape and acoustically optimizing the hearing aid are used for determining the distance. Only the signal-processing unit must additionally be adapted for determining the projection image in respect of determining the distance and for determining the eardrum contour.

A basic concept of the invention can be summarized as follows: the invention relates to an apparatus and a method for measuring the distance to the eardrum. The apparatus comprises an optical sensor 22 and a signal-processing device 23. According to a basic idea of the invention, the optical sensor 22 acquires an image of the eardrum 12 and the signal-processing device 23 determines an area A1, A2 or separation d1, d2, d3 extending perpendicular to the distance D to be measured in the image and determines the distance D to the eardrum 12 as a function of the determined area A1, A2 or separation d1, d2, d3. According to a basic idea of the invention, the method comprises the steps of S1 acquiring an image of the eardrum 12, S2 determining an area A1, A2 or separation d1, d2, d3 extending perpendicular to the distance D to be measured in the image, and S3 determining the distance D as a function of the determined area A1, A2 or separation d1, d2, d3. In an advantageous development, a projection image is projected onto or into the vicinity of the eardrum 12 and then the distance D advantageously can be determined from the separation d1, d2, d3 between the projection image 31 and the eardrum 12 or the image center of the image. Advantageously, use can be made of an optical sensor, which in any case is possibly available for other purposes. Advantageously, image-processing algorithms are available for analyzing image data in respect of conventional geometric imaging features, namely area or separation, and do not require any particular implementation by the apparatus. Additionally, such image-processing algorithms function largely independently of interferences in the image quality.

1. An apparatus for measuring a distance between a distal end of an instrument inserted into a canal and a terminal boundary of the canal, comprising:
an optical sensor disposed at the distal end of the instrument and configured to acquire an image of the terminal boundary of the canal;
a signal-processing device connected to said optical sensor, said signal-processing device determining an area or separation extending perpendicularly to the distance to be measured in the image, and determining the distance between the distal end of the instrument and the terminal boundary of the canal in dependence on the area or separation.

2. The apparatus according to claim 1, wherein the instrument is configured for insertion into an auditory canal and the terminal boundary of the canal is formed by an eardrum.

3. The apparatus according to claim 1, wherein said optical sensor has a constant optical aperture.

4. The apparatus according to claim 1, wherein said signal-processing device further determines the distance as a function of an optical aperture of said optical sensor.

5. The apparatus according to claim 1, wherein said signal-processing device is configured to determine an area of the terminal boundary in the image received from said optical sensor and to determine the distance as a function of the area.

6. The apparatus according to claim 1, wherein said signal-processing device is configured to determine an area not containing the terminal boundary in the image received from said optical sensor and to determine the distance as a function of the area.

7. The apparatus according to claim 1, which further comprises an optical projector for projecting a predetermined projection image, and wherein said optical projector is disposed to project the projection image in a direction of the terminal boundary, said signal-processing device determines a separation in the image between the projection image and said terminal boundary and determines the distance as a function of the separation.

8. The apparatus according to claim 7, wherein the predetermined projection image is contoured to match an expected contour of the terminal boundary.

9. The apparatus according to claim 7, wherein said signal-processing device determines a separation between a contour of the projection image and a contour of the terminal boundary in the image and determines the distance as a function of the separation.

10. A method of measuring a spacing distance between a distal end of an instrument, configured for insertion into a canal, and a terminal boundary at an end of the canal into which the instrument has been inserted, the method which comprises:
acquiring an image of the terminal boundary at the end of the auditory canal;
in the image, determining an area or separation extending perpendicular to the spacing distance to be measured; and
determining the spacing distance as a function of the area or separation.

11. The method according to claim 10, wherein the canal is an external auditory canal and the terminal boundary of the canal is an eardrum.

12. The method according to claim 10, which comprises additionally taking into account a dependence on a optical aperture of an optical sensor used to acquire the image when determining the spacing distance.

13. The method according to claim 10, which further comprises:
determining an area of the terminal boundary in the image; and
determining the spacing distance in dependence on the area.

14. The method according to claim 10, which further comprises:
determining an area not containing the terminal boundary in the image; and
determining the spacing distance in dependence on the area.

15. The method according to claim 10, which further comprises:
projecting a predetermined projection image in a direction of the terminal boundary;
determining a separation between the projection image and the terminal boundary in the image; and
determining the spacing distance in dependence on the separation between the projection image and the terminal boundary.

16. The method according to claim 15, which comprises providing the predetermined projection image as a contoured image to match an expected contour of the terminal boundary at the end of the canal.

17. The method according to claim 10, which further comprises:
determining a separation between a contour of the projection image and a contour of the terminal boundary in the image; and
determining the spacing distance in dependence on the separation.
